(19) United States
(12) Patent Application Publication
(10) Pub. No.: US 2026/0244135 A1
(43) Pub. Date: Aug. 20, 2026

(54) INSPECTION APPARATUS AND CONTROL METHOD THEREFOR

(71) Applicant: CANON KABUSHIKI KAISHA, Tokyo (JP)

(72) Inventor: YUKICHIKA ICHIHASHI, Chiba (JP)

(21) Appl. No.: 19/539,158

(22) Filed: Feb. 13, 2026

(30) Foreign Application Priority Data
Feb. 19, 2025 (JP) 2025-025228

(51) Int. Cl. G03G 15/00; G06F 3/12; H04N 1/00

(52) U.S. Cl. CPC G03G 15/502; G06F 3/1208; H04N 1/00; H04N 1/00005

(57) ABSTRACT

An inspection apparatus that inspects an abnormality of a sheet printed by an image forming apparatus, the inspection apparatus comprising: one or more memory devices that store a set of instructions; and one or more processors that execute the set of instructions to: acquire an image for printing; acquire a difference in position between the image for printing and the image for printing in a state of being printed on the sheet by the image forming apparatus; acquire an image of a preprinted sheet; execute processing on the image for printing according to the difference; and output an inspection setting screen including the image for printing subjected to the processing and an image of the preprinted sheet.

### BACKGROUND

### Field of the Technology

The present disclosure relates to an inspection apparatus and a control method therefor.

### Description of the Related Art

Digital printing technology based on electrophotographic technology or the like, which is called print-on-demand, has become common mainly in the printing industry. Use of print-on-demand for variable data print (VDP) that changes images and characters to be printed for each copy has been increasing. In the VDP, printing without contamination or printing of correct data is required.

In known inspection for image quality of printed matter, it has been common for a worker to visually confirm the printed matter. Therefore, the inspection result depends on sensory evaluation by the worker, and there is a possibility that variation in the inspection level occurs. The inspection time depends on the skill level of the worker, and there is a limit to shortening the inspection time since it relies on manual labor. Therefore, in recent years, an automatic inspection apparatus that automatically performs image quality inspection of printed matter has been devised.

In determination by this automatic inspection apparatus, document image data generated in an image forming apparatus is used as reference data, scan data in which an image printed on recording paper is read by a sensor such as a scanner is used as inspection image data, and comparison between them is performed. The automatic inspection apparatus displays the reference data as a preview image on a display or the like connected via a network or the like before the start of printing. The user performs inspection settings such as inspection portion, inspection type, or inspection strength of the print image with reference to this preview image.

Here, in the automatic inspection apparatus, recording paper (hereinafter, also referred to as printed matter) on which document image data is printed may be recording paper (hereinafter, also referred to as preprinted paper) printed in advance by another image forming apparatus. In such a case, since the reference data is document image data generated in the image forming apparatus, the image already printed on the preprinted paper is not included in the preview image. Furthermore, when printing document image data onto preprinted paper, it is difficult to ensure in advance the accuracy of the print position of the document image data. For the above reason, even in the image forming apparatus to which the automatic inspection apparatus is connected, first, visual confirmation (test printing) of the print position or the like is performed by experimentally printing a document image on several pages of preprinted paper in the image forming apparatus. Thereafter, inspection setting is performed, printing is actually executed, and inspection of the printed sheet is performed.

However, such test printing increases inspection manhours. Therefore, in order to suppress an increase in the inspection manhours, Japanese Patent Laid-Open No. 2009-199205 proposes a method for compositing image data of preprinted paper acquired in advance and document image data to perform preview display.

However, it is difficult to reproduce, in the preview image, occurrence of image distortion, position deviation, and the like that occur when an image is actually printed on preprinted paper by the image forming apparatus. Therefore, it is difficult to recognize on the preview screen that, for example, the ruled line printed in advance on preprinted paper and the document image overprinted on the preprinted paper overlap due to position deviation of printing of the document image. For example, there is a possibility that information (such as a ruled line of preprint printing) originally positioned outside a designated area is included in the designated area due to position deviation of printing in the image forming apparatus with respect to the designated area for character inspection set on the preview image. In such a case, erroneous determination may occur in OCR inspection. Hence, when inspection setting is performed using such a preview screen, the inspection accuracy may be deteriorated.

### SUMMARY

The present disclosure enables realization of a technology that is made in view of at least one of the above problems and can suppress a decrease in inspection accuracy in a case where inspection setting of a preprinted sheet on which an image is overprinted is performed using a print preview screen.

One aspect of the present disclosure provides an inspection apparatus that inspects an abnormality of a sheet printed by an image forming apparatus, the inspection apparatus comprising: one or more memory devices that store a set of instructions; and one or more processors that execute the set of instructions to: acquire an image for printing; acquire a difference in position between the image for printing and the image for printing in a state of being printed on the sheet by the image forming apparatus; acquire an image of a preprinted sheet; execute processing on the image for printing according to the difference; and output an inspection setting screen including the image for printing subjected to the processing and an image of the preprinted sheet.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an image inspection system according to one embodiment.

FIG. 2 is a structure diagram of each apparatus according to one embodiment.

FIG. 3 is a hardware block diagram of each apparatus according to one embodiment.

FIGS. 4A, 4B, and 4C are software block diagrams of each apparatus according to one embodiment.

FIGS. 5A and 5B are flowcharts of processing according to one embodiment.

FIGS. 6A, 6B, and 6C are views illustrating a display screen according to one embodiment.

FIGS. 7A to 7E are views illustrating images according to one embodiment.

FIG. 8 is a view illustrating a display screen according to one embodiment.

FIG. 9 is a flowchart of processing according to one embodiment.

FIG. 10 is a flowchart of processing according to one embodiment.

FIG. 11 is a flowchart of processing according to one embodiment.

FIGS. 12A and 12B are views illustrating images according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the present description, the term “image forming apparatus” broadly includes an apparatus that forms (records) an image on a recording material (recording medium), such as a single function printer, a copying machine, a multifunction peripheral, and a commercial printing machine. The image forming apparatus may be a system (image forming system) in which an image forming apparatus main body that forms an image on a recording material and equipment such as a sheet processing apparatus and a sheet feeding apparatus are connected.

### Embodiment

### System Configuration

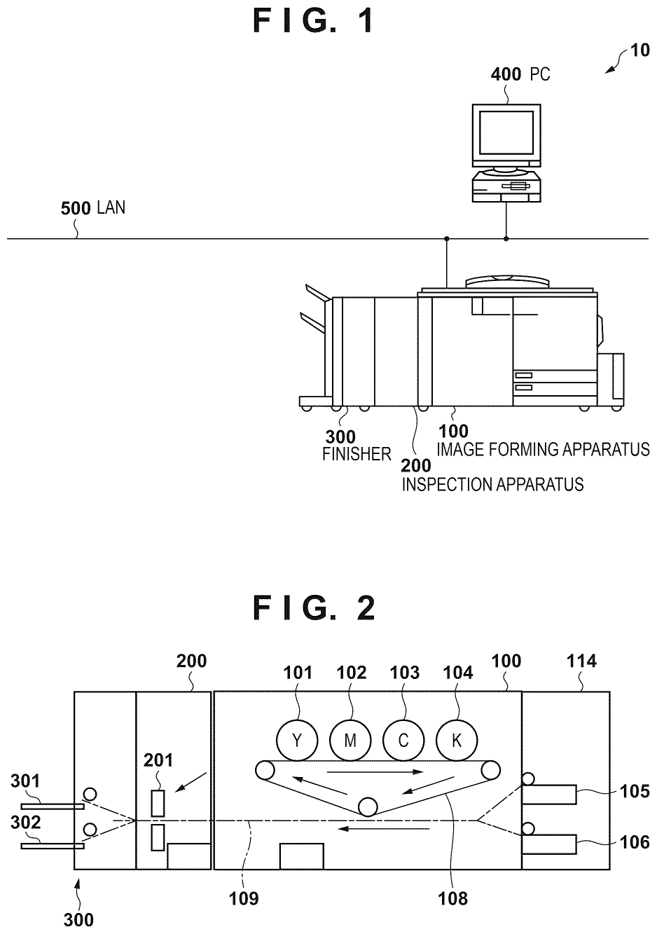

An outline of an image inspection system 10 according to the present embodiment will be described with reference to FIG. 1. Note that in the following description, the image forming apparatus is also referred to as a multifunction peripheral (MFP).

The image inspection system 10 is configured to include an image forming apparatus 100, an inspection apparatus 200 (an example of “inspection apparatus”), a finisher 300, and a personal computer (PC) 400. These apparatuses are connected to one another via a LAN 500. The image forming apparatus 100, the inspection apparatus 200, and the finisher 300 are connected so that a medium can be directly conveyed. Note that in the following description, the image forming apparatus 100, the inspection apparatus 200, and the finisher 300 are collectively referred to as an automatic inspection apparatus.

The inspection apparatus 200 inspects whether or not there is an abnormality in the printed matter sequentially conveyed from the image forming apparatus 100. Here, the abnormality deteriorates the quality of the printed matter, and is, for example, contamination caused by a color material adhering to an unintended portion at the time of printing, or color loss caused by a sufficient color material not adhering to an intended portion.

Furthermore, the inspection apparatus 200 inspects a variable area portion in variable printing including a variable area portion whose outer shape changes in a plurality of pages, such as a one-dimensional code such as a character string or a barcode, or a two-dimensional code such as a QR code (registered trademark). The inspection apparatus 200 performs, for example, a data readability inspection for checking whether or not a character string or a barcode is readable. The inspection apparatus 200 performs, for example, a data collation inspection for collating a reading result of a character string or a barcode with a correct answer. The inspection apparatus 200 performs, for example, a front and back match inspection for checking whether or not the reading results of the data inspection areas set for the front surface and the back surface match.

That is, the inspection apparatus 200 performs a print image inspection for detecting an abnormality of a pattern portion of the printed matter, and a data inspection including a data readability inspection and a data collation inspection. Note that an inspection processing unit that performs the print image inspection or the data inspection is not necessarily included in the inspection apparatus 200, and may be configured to perform the inspection processing by, for example, an information processing apparatus (not illustrated) as an inspection PC communicably connected to the inspection apparatus 200. Note that in the present embodiment, the barcode inspection refers to an inspection that can also inspect a two-dimensional code such as a QR code. The image inspection system 10 in the present embodiment is configured to include at least the inspection apparatus 200 that inspects printed matter.

The structures of the image forming apparatus 100, the inspection apparatus 200, and the finisher 300 will be described with reference to FIG. 2. The image forming apparatus 100 is configured to include image forming stations 101 to 104 for performing color printing of yellow, magenta, cyan, and black. Each of the image forming stations 101 to 104 executes an image forming method such as an electrophotographic method or an inkjet method. Note that the image forming method is not limited to these methods. The image forming apparatus 100 may be configured to include only the image forming station 104 that corresponds to single-color printing, for example, black printing.

The image forming apparatus 100 is configured to include a paper feeding apparatus 114. The paper feeding apparatus 114 includes a paper feed stage, and feeds a recording sheet such as paper from a paper cassette 105 or a paper cassette 106 to the inside of the image forming apparatus 100. In this manner, printing can be performed in the image forming apparatus 100. The present embodiment assumes that printed recording paper (preprinted paper) is loaded on the paper cassette 105. It is assumed that normal recording paper (blank paper) having the same paper type and size as those of the paper cassette 105 is loaded on the paper cassette 106. Note that in the present embodiment, the preprinted paper to be loaded on the cassette is A4 size plain paper, but the paper type and the like are not limited to this. The printed recording paper (preprinted paper) is an example of “preprinted sheet”.

The image forming apparatus 100 is configured to include an intermediate transfer belt 108 and a paper conveyance path 109. The intermediate transfer belt 108 is rotatable, and color material is transferred from the image forming stations 101 to 104 to the intermediate transfer belt 108 in a rotated state. Then, the color material transferred to the intermediate transfer belt 108 is transferred onto a medium conveyed downstream on the paper conveyance path 109 at a contact portion with this medium.

The inspection apparatus 200 is provided such that the paper conveyance path 109 therein is connected to the paper conveyance path 109 of the image forming apparatus 100. The printed medium is directly conveyed to the inside of the inspection apparatus 200 via the paper conveyance path 109. The inspection apparatus 200 is configured to include image sensors 201 disposed in pairs with the paper conveyance path 109 therebetween. The image sensor 201 shoots the front and back of the medium on the paper conveyance path 109. The image shot by the image sensor 201 is used at the time of registration and inspection of a print sample image.

The finisher 300 is configured to include a plurality of paper discharge units (301 and 302) connected to the inspection apparatus 200. The finisher 300 can sort the printed matters that have been inspected into the paper discharge units (301 and 302) based on the inspection result. For example, printed matter whose inspection result is OK is discharged to the paper discharge unit 301, and printed matter whose inspection result is NG is discharged to the paper discharge unit 302 for purge.

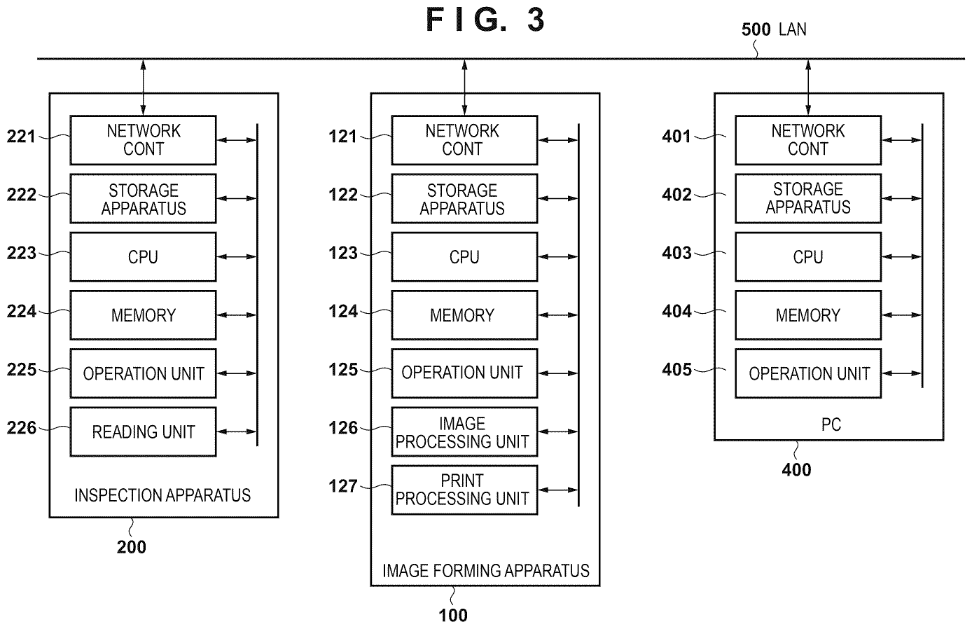

A hardware block of each apparatus will be described with reference to FIG. 3. The image forming apparatus 100 is configured to include a network controller (network CONT) 121, a storage apparatus 122, a CPU 123, a memory 124, an operation unit 125, an image processing unit 126, and a print processing unit 127.

The network controller 121 is configured to include a communication module, connects the image forming apparatus 100 and the LAN 500, and controls communication of information. The processing to be executed by the image forming apparatus 100 is implemented by the CPU 123 reading a program stored in the storage apparatus 122 into the memory 124 and executing the program. The operation unit 125 displays information onto a screen in order to accept an external input operation. The image processing unit 126 converts the electronic image data (e.g., multivalued image data of CIE-sRGB) into electronic image data for printing (e.g., halftone image of CMYK). Using the image forming stations 101 to 104, the print processing unit 127 transfers the electronic image data for printing to the recording paper fed from the paper feeding apparatus 114. In this manner, printing is performed.

The inspection apparatus 200 is configured to include a network controller 221, a storage apparatus 222, a CPU 223, a memory 224, an operation unit 225, and a reading unit 226. The network controller 221 is configured to include a communication module, connects the inspection apparatus 200 and the LAN 500, and controls communication of information. The processing to be executed by the inspection apparatus 200 is implemented by the CPU 223 reading a program stored in the storage apparatus 222 into the memory 224 and executing the program.

The operation unit 225 is, for example, a button, a keyboard, or the like, and accepts a user input operation. The operation unit 225 is, for example, a touch panel display. In such a case, the operation unit 225 accepts a user input operation and functions also as a display unit that displays a print sample described later and an inspection setting screen. Note that the screen to be displayed by the display unit is controlled by the CPU 223, and in the present embodiment, the CPU 223 may be referred to as a display control unit. The reading unit 226 is configured to include the image sensor 201. Using this reading unit 226, the CPU 223 reads the recording paper conveyed through the paper conveyance path 109, and converts the read data into electronic image data (e.g., multivalued image data of RGB).

The PC 400 issues a print instruction to the image forming apparatus 100. The PC 400 is configured to include a network controller 401, a storage apparatus 402, a CPU 403, a memory 404, and an operation unit 405. The network controller 401 is configured to include a communication module, connects the PC 400 and the LAN 500, and controls communication of information. The processing to be executed by the PC 400 is implemented by the CPU 403 reading a program stored in the storage apparatus 402 into the memory 404 and executing the program. The operation unit 405 is configured to include, for example, a mouse and a keyboard (not illustrated), and enables operation of a program. The operation unit 405 is configured to include, for example, a display (not illustrated), and enables screen display.

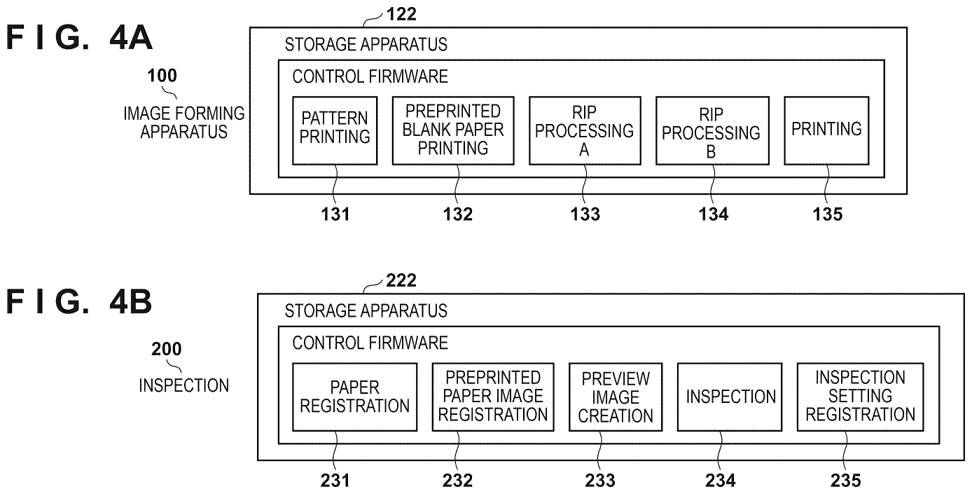

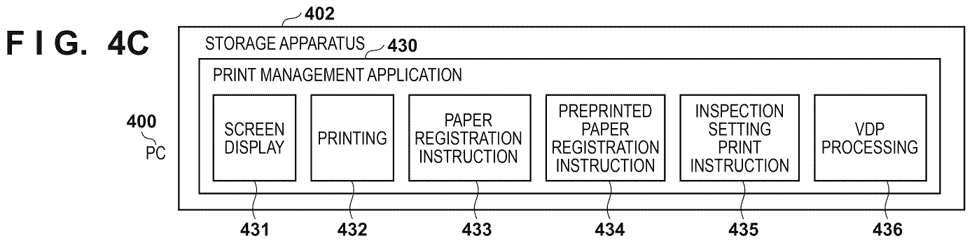

A block configuration of a program stored in each of the storage apparatus 122, the storage apparatus 222, and the storage apparatus 402 of the respective apparatuses will be described with reference to FIGS. 4A to 4C. FIG. 4A illustrates a program stored in the storage apparatus 122 of the image forming apparatus 100. Similarly, FIG. 4B illustrates a program stored in the storage apparatus 222 of the inspection apparatus 200, and FIG. 4C illustrates a program stored in the storage apparatus 402 of the PC 400. Each program illustrated in FIGS. 4A to 4C will be described later in detail.

Note that although the inspection apparatus 200 includes the operation unit 225, the CPU 223 of the inspection apparatus 200 generates a hypertext markup language (HTML) file for display. Then, using Hypertext Transfer Protocol (HTTP), it is possible to cause the operation unit 405 of the PC 400 to display this file and accept an operation. That is, in the present embodiment, the apparatus that performs display and accepts operations is not limited to a specific apparatus.

Next, an outline of the inspection function of the inspection apparatus 200 will be described. Types of inspection to be executed by the inspection apparatus 200 are, for example, “print image inspection” and “data inspection”. Details of these inspections will be described below.

### Print Image Inspection

Using the reading unit 226, the CPU 223 of the inspection apparatus 200 reads printed matter conveyed from the image forming apparatus 100, and acquires a scanned image (read image) of an inspection target. The CPU 223 stores the acquired scanned image of the inspection target into the memory 224. Subsequently, the CPU 223 acquires a difference value between a reference image stored in the memory 224 in advance as a correct answer image and the scanned image of the inspection target. Next, the CPU 223 performs inspection by comparing, for each pixel, the acquired difference value with an inspection threshold (e.g., contrast, size, or the like) of each inspection item. Then, the CPU 223 stores the inspection result in the memory 224. The inspection result to be stored is, for example, information on whether or not there is an abnormality in the printed matter, a type of the detected abnormality (spot or streak), position information on the abnormality when displayed on the operation unit 225, or the like.

### Data Inspection

Using the reading unit 226, the CPU 223 of the inspection apparatus 200 reads the printed matters sequentially conveyed from the image forming apparatus 100 and acquires a scanned image of the inspection target. Then, the CPU 223 stores the acquired scanned image of the inspection target into the memory 224. Subsequently, the CPU 223 performs, on the scanned image, clipping processing of clipping an area including data such as a character string, a barcode, and a QR code from coordinates designated in advance. Then, in a case where the clipped image includes a character, the CPU 223 executes OCR processing by using a character shape font for character recognition (OCR) set in advance. In a case where the clipped image includes a barcode, the CPU 223 performs decoding processing using a barcode standard.

At this time, the CPU 223 determines whether or not the character string or the barcode in the area set to perform data inspection is readable. Then, the CPU 223 determines OK in a case of determining that it is readable, and determines NG in a case of determining that it is not readable. The CPU 223 can also perform a data collation inspection of collating a result of the read character string or barcode, which is the extracted data, with corresponding data (correct answer data) of a correct answer CSV file prepared in advance to determine whether or not these pieces of data match. Also here, the CPU 223 determines as OK in a case of determining that these pieces of data match, and determines as NG in a case of determining that these pieces of data do not match. The CPU 223 stores the inspection result into the storage apparatus 222. The inspection result to be stored is, for example, a result of a character string or barcode read from the printed matter, a result of collation with the correct answer data, position information on the read character or barcode when displayed on the operation unit 225, or the like.

### Processing Example

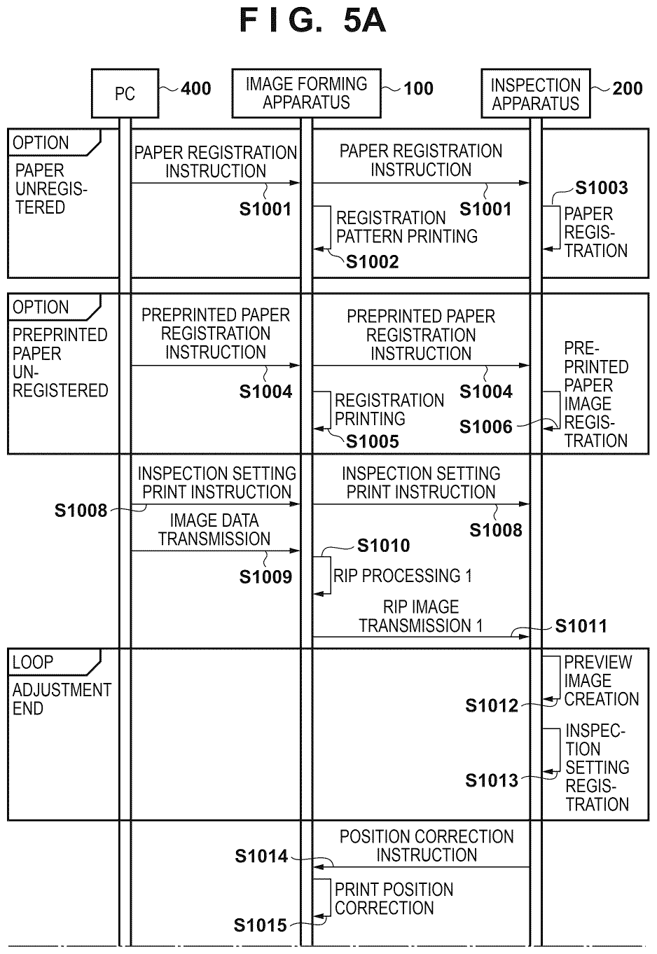

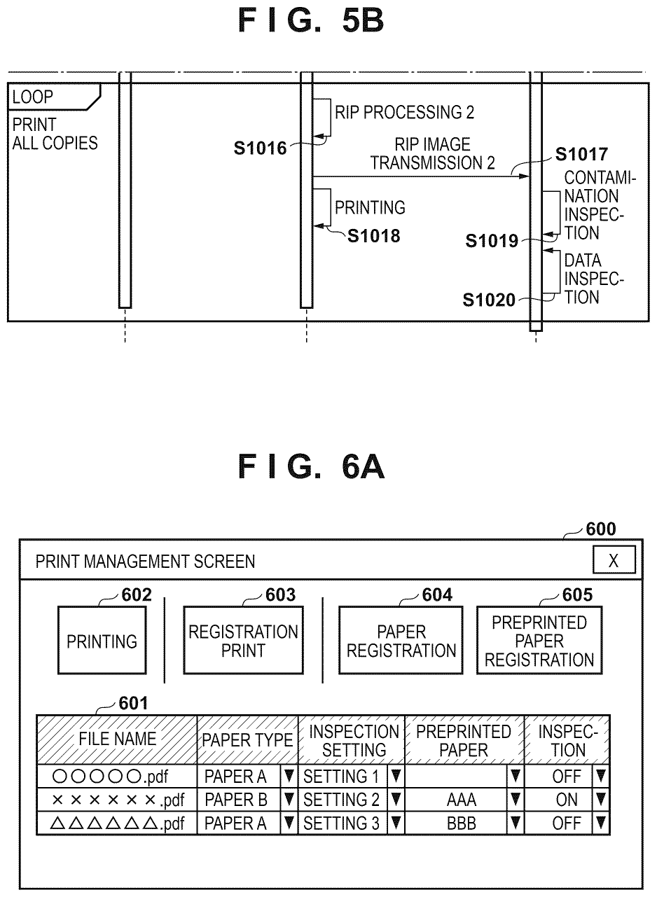

Next, sequence processing of the image inspection system 10 will be described with reference to FIGS. 5A and 5B. Note that this processing is implemented by the CPUs provided in the image forming apparatus 100, the inspection apparatus 200, and the PC 400, respectively, reading programs stored in the respective storage apparatuses into the respective memories and executing them. When transmitting and receiving a command and data such as an image, each CPU accesses another apparatus through the LAN 500 using the network controller to store and read data. The series of operations will be omitted in the description of each process.

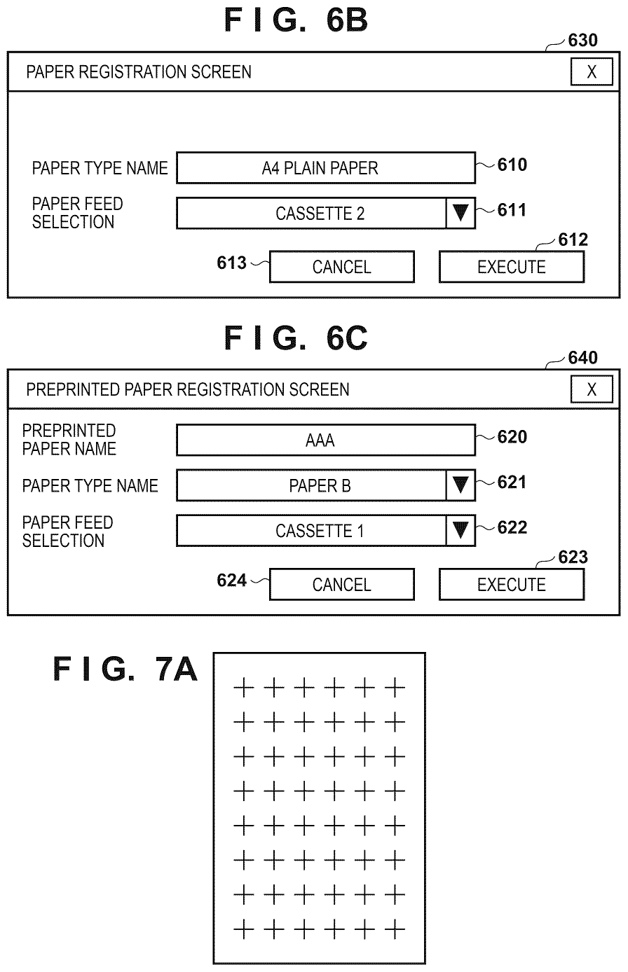

First, before the sequence processing is executed, the CPU 403 of the PC 400 causes the operation unit 405 to display a print management screen by executing screen display 431. Note that this print management screen may be received from the inspection apparatus 200. FIG. 6A illustrates a print management screen 600. The print management screen 600 includes a print file selection list 601, a print button 602, a registration print button 603, a paper registration button 604, and a preprinted paper registration button 605. Note that the print file selection list 601 is an example of “list”. The print button 602 is an example of “second object”. The registration print button 603 is an example of “third object”. The paper registration button 604 is an example of “fourth object”. The preprinted paper registration button 605 is an example of “fifth object”.

The print file selection list 601 includes a list of information on image files for printing registered in a print management application 430. The list includes a file name, a paper setting, an inspection setting number, a name of preprinted paper, and ON/OFF of inspection implementation, and these items are displayed in a selectable manner. Note that the paper setting on the print management screen 600 may be displayed such that the paper type is selectable, or may be displayed such that which paper to use, the paper loaded in either the paper cassette 105 or the paper cassette 106 is selectable. The inspection setting and the setting of the preprinted paper will be described later.

The print button 602 is a button for the image file in a state of being selected in the print file selection list 601 to be printed according to the setting. The registration print button 603 is a button for specifically setting inspection using the inspection apparatus 200 when printing the image file in the state of being selected in the print file selection list 601. The paper registration button 604 is a button for executing adjustment for improving accuracy when performing inspection using the inspection apparatus 200. That is, the paper registration button 604 is used in a case where the type of paper to be inspected (thickness and size) is unregistered, or in a case where improvement of the accuracy of inspection is desired. The preprinted paper registration button 605 is a button for registering the preprinted paper into the inspection apparatus 200.

The description of sequence flows of FIGS. 5A and 5B will be started. In a case where the information regarding the printing paper is unregistered, S1001 to S1003 are executed. That is, in S1001, the CPU 403 of the PC 400 accepts the operation input on the paper registration button 604, and executes a paper registration instruction 433. In the paper registration instruction 433, the CPU 403 first displays a paper registration screen 630 of FIG. 6B on the operation unit 225. The paper registration screen 630 includes a paper type name 610, paper feed selection 611, an execution button 612, and a cancel button 613.

The paper type name 610 is a box for setting a name that can be identified when inspection is performed. The paper feed selection 611 is a pull-down menu for selecting the paper cassette 105 or the paper cassette 106. Note that here, it is assumed that paper feed from the paper cassette 106 (cassette 2) is selected. The execution button 612 is a button for instructing paper registration. The cancel button 613 is a button for canceling the settings of the paper type name 610 and the paper feed selection 611. When accepting an operation input on the execution button 612 in a state where the paper type name 610 and the paper feed selection 611 are set, the CPU 403 issues a paper registration instruction to the image forming apparatus 100 and the inspection apparatus 200. At this time, the CPU 403 transmits information to the image forming apparatus 100 and the inspection apparatus 200 in order to share the setting values of the paper type name 610 and the paper feed selection 611. Then, the CPU 123 of the image forming apparatus 100 receives the paper registration instruction using the network controller 121. The CPU 223 of the inspection apparatus 200 also receives the paper registration instruction using the network controller 221.

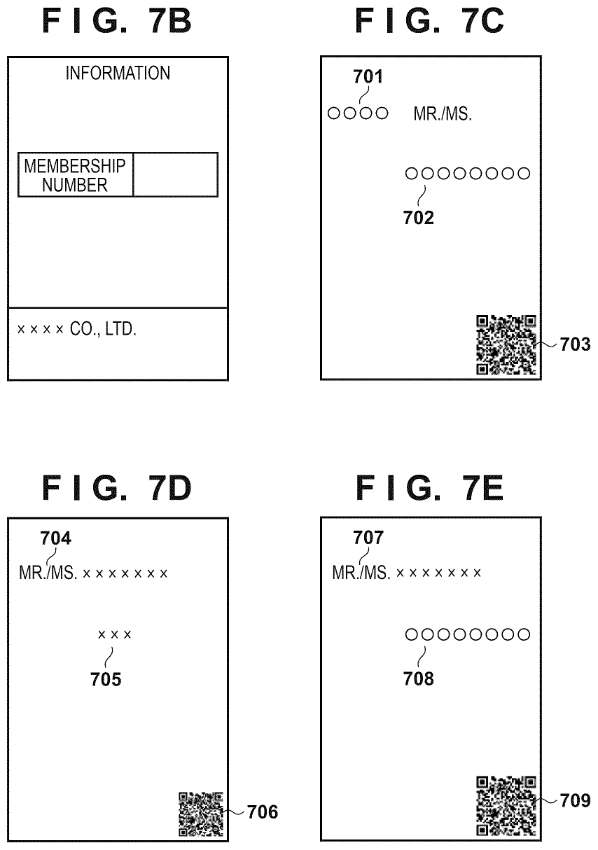

In S1002, the CPU 123 of the image forming apparatus 100 executes pattern printing 131 in order to perform printing of a paper registration pattern from the paper cassette 106. FIG. 7A illustrates a printed paper registration pattern. The printing of the paper registration pattern indicates that the CPU 123 prints, onto the printing paper of the paper cassette 106, a pattern for checking at which position in the main scanning and sub-scanning directions an image is to be printed. Therefore, the CPU 123 deploys a pattern with feature points arranged at equal intervals into the memory 124 and causes the pattern to be printed. However, in the image forming apparatus 100, due to the occurrence of print deviation in the vertical and horizontal directions, the center point of each pattern is printed at a position distorted from a desired position by about several millimeters at the maximum in accordance with the characteristics of the image forming apparatus 100.

In S1003, the CPU 223 of the inspection apparatus 200 controls the image sensor 201 to be in a scanning standby mode for the printed matter on which the pattern is printed. Then, when the reading unit 226 reads this printed matter, the CPU 223 executes paper registration 231. Details of the paper registration 231 will be described later. Data of the position deviation after the paper registration 231 is executed is assumed to be stored in the storage apparatus 222 of the inspection apparatus 200.

Next, in a case where the information regarding the preprinted paper is unregistered, S1004 to S1006 are executed. That is, in S1004, the CPU 403 of the PC 400 accepts an operation input on the preprinted paper registration button 605, and executes preprinted paper image registration 232. That is, the CPU 403 first causes the operation unit 225 to display a preprinted paper registration screen 640 as illustrated in FIG. 6C. The preprinted paper registration screen 640 includes a preprinted paper name 620, a paper type name 621, paper feed selection 622, an execution button 623, and a cancel button 624.

The preprinted paper name 620 is a box for setting a name that is identifiable when inspection is performed. The paper type name 621 is a pull-down menu for selecting a paper type name when the paper registration 231 is executed. The paper feed selection 622 is a pull-down menu for selecting the paper cassette 105 or the paper cassette 106. Note that here, it is assumed that the paper cassette 105 (cassette 1) is selected. The CPU 403 accepts an operation input on the execution button 623 in a state where the paper type name and the paper feed selection are set. Then, using the network controller, the CPU 403 issues a preprinted paper registration instruction to the image forming apparatus 100 and the inspection apparatus 200. At this time, the CPU 403 transmits information to the image forming apparatus 100 and the inspection apparatus 200 in order to share the setting values of the preprinted paper name 620, the paper type name 621, and the paper feed selection 622. The CPU 123 of the image forming apparatus 100 receives the preprinted paper registration instruction from the PC 400 using the network controller 121. The CPU 223 of the inspection apparatus 200 also receives the preprinted paper registration instruction from the PC 400 using the network controller 221.

In S1005, the CPU 123 of the image forming apparatus 100 executes preprinted blank paper printing 132. More particularly, FIG. 7B illustrates preprinted paper. The preprinted paper is printed paper printed in large quantities by an offset printing machine or the like. In a case where the preprinted paper is loaded on the paper cassette 105 of the image forming apparatus 100, the CPU 123 of the image forming apparatus 100 causes the preprinted paper to be fed from the paper cassette 105 to the paper conveyance path 109. On the paper conveyance path 109, if toner has been transferred to the intermediate transfer belt 108, the toner is transferred to the preprinted paper. However, when the preprinted paper image registration 232 is executed, preprinted paper that is not overprinted is registered. In such a case, the CPU 123 conveys the preprinted paper to the inspection apparatus 200 skipping transferring the toner to the preprinted paper.

In S1006, the CPU 223 of the inspection apparatus 200 controls the image sensor 201 to be in a scanning standby mode for the preprinted paper. When the reading unit 226 (an example of “third acquisition unit”) reads the preprinted paper, the CPU 223 executes the preprinted paper image registration 232. That is, the CPU 223 stores, into the storage apparatus 222, data of an image (an example of “preprinted sheet image”) obtained by reading the preprinted paper, together with the setting value input to the preprinted paper name 620 on the preprinted paper registration screen 640 of FIG. 6C. Note that S1004 to S1006 need not be performed as long as the preprinted paper has already been registered. Then, the processing proceeds to S1008.

Next, inspection setting processing will be described. The inspection setting processing is setting processing regarding inspection of coordinates and the like of image inspection and data inspection in the image for printing. In S1008, the CPU 403 of the PC 400 accepts a pressing operation on the registration print button 603 on the print management screen 600. Then, the CPU 403 executes an inspection setting print instruction program 435 to issue an inspection setting print instruction to the image forming apparatus 100 and the inspection apparatus 200. The CPU 123 of the image forming apparatus 100 receives this inspection setting print instruction using the network controller 121. The CPU 223 of the inspection apparatus 200 also receives this inspection setting print instruction using the network controller 221.

In S1009, the CPU 403 of the PC 400 sends image data for performing inspection registration to the image forming apparatus 100. This image data is, for example, image data such as a PDF file designated in the print file selection list 601 on the print management screen 600. Note that the image data of the present embodiment includes variable data. That is, the image data includes a fixed part whose content does not change for each frame and a variable part such as a character string or a barcode whose content changes for each frame in the image data by a variable data print (VDP) function. The image data including the fixed part and the variable part becomes a bitmap image for printing by RIP processing described later. The CPU 403 also transmits the setting data of the preprinted paper name registered in S1006 together with the image data. The CPU 123 of the image forming apparatus 100 receives the image data and the setting data of the preprinted paper name using the network controller 121.

In S1010, the CPU 123 of the image forming apparatus 100 executes RIP processing A133. That is, the CPU 123 extracts, from the image data, data of the variable part having the maximum size among a plurality of variable parts positioned at the same coordinates over a plurality of inspection target images to generate the image data of the inspection target.

FIGS. 7C and 7D illustrate images for printing generated when normal RIP processing is executed on two inspection target image data. On the other hand, FIG. 7E illustrates an image for printing generated when the RIP processing A133 is executed. As illustrated in FIG. 7E, the CPU 123 further compares variable data 701 and variable data 704 at the same position regarding the images for printing of FIGS. 7C and 7D. Then, the CPU 123 adopts the variable data 704, which has a large number of characters, as variable data 707 for an RIP image. In a case where variable data 702 and variable data 705 at the same position are compared, the variable data 702 has a larger number of characters. Therefore, the CPU 123 adopts the variable data 702 as variable data 708 for the RIP image.

In a case where the variable data is a QR code or the like, the CPU 123 compares the data amount or the size of the shape of the QR code at the time of actual printing. That is, the CPU 123 compares the sizes of a QR code 703 and a QR code 706, and adopts the QR code 703, which has a larger size, as a QR code 709 for the RIP image. Note that the variable data 701 to 705 and the QR codes (703 and 706) are examples of “variable parts”. The variable data 701 to 705 are examples of “character images”. The character “Mr./Ms.” in FIGS. 7C and 7D is an example of “fixed part that does not change for each frame”.

Note that S1010 can be implemented by executing the RIP processing A133 alone of the image forming apparatus 100, but for example, VDP processing 436 of the PC 400 may have a function of selecting a character string and a data string whose size is the maximum. In such a case, in the image data transmission of S1009, the image data in a state where the maximum character string and data string are already adopted is to be transmitted.

In S1011, the CPU 123 (an example of “transmission unit”) transmits the RIP image (bitmap image) of FIG. 7E generated in the RIP processing A133 to the inspection apparatus 200 using the network controller 121. Then, the CPU 223 (an example of “first acquisition unit”) of the inspection apparatus 200 receives this RIP image (an example of “image for printing”) using the network controller 221.

In S1012, the CPU 223 of the inspection apparatus 200 executes preview image creation 233 to create a preview image. That is, the CPU 223 reads, from the storage apparatus 222, the paper distortion data acquired in S1003 and the preprinted paper image data acquired in S1006. Then, the CPU 223 (an example of “compositing unit”) creates a preview image using the read data and the RIP image acquired in the RIP processing A133. Details of the preview image creation 233 will be described later.

In S1013, the CPU 223 executes inspection setting registration 234. That is, the CPU 223 (an example of “output unit”) displays (an example of “output”) an inspection setting screen for inspection setting adjustment. Note that the CPU 223 causes the operation unit 225 of the inspection apparatus 200 to display the screen, but may transmit (an example of “output”) the inspection setting screen to the image forming apparatus 100 or the PC 400. Then, the operation unit 125 of the image forming apparatus 100 or the operation unit 405 of the PC 400 may display the inspection setting screen.

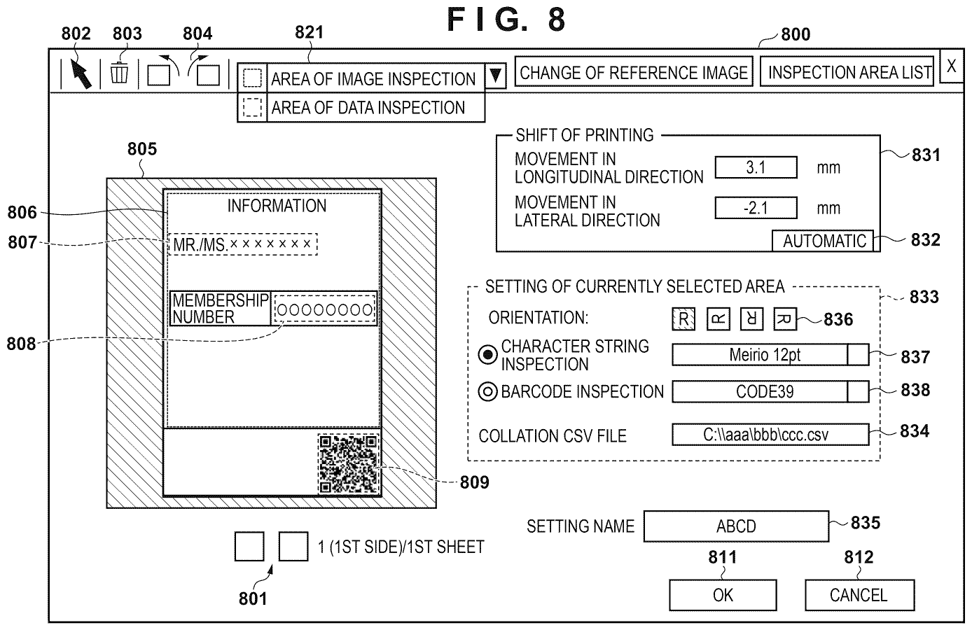

An inspection setting screen 800 will be described with reference to FIG. 8. The inspection setting screen 800 includes buttons (801 to 804, 811, 812, and 836), a display area 805, inspection areas 806 to 809, and a list box 821. The inspection setting screen 800 includes setting areas (831, 833, 837, and 838), an automatic adjustment button 832, a collation CSV file 834, and a setting name 835. The CPU 223 of the inspection apparatus 200 causes the operation unit 225 to display the inspection setting screen 800 and accepts various inputs to the inspection setting screen 800 to execute predetermined processing.

The button 801 is a button for changing the display page of the reference image, and is a button to be used when changing the page or the like of the reference image. The button 802 is a selection button for the inspection area, and is a button to be pressed by an operator in a case of desiring to select an already set area. The button 803 is a delete button for the inspection area, and is a button to be pressed by the operator in a case of desiring to delete the selected area. The button 804 is a button for rotating the image displayed in the display area 805. The display area 805 is a display area for displaying the preview image created in the preview image creation 233.

The button 811 is an OK button for saving the input setting and causing the inspection setting screen 800 to transition to the print management screen 600 illustrated in FIG. 6A. The setting name 835 is a box to which a name can be input. By inputting the name in such a box, it is possible to reuse the setting on the inspection setting screen 800 as it is in a case of performing the same inspection again. The button 811 is also a button for establishing the setting on the inspection setting screen 800. Note that upon accepting the operation on the button 811, the CPU 223 may cause the inspection setting screen 800 to transition to an inspection screen not illustrated so that the inspection can be executed.

The button 812 is a button for canceling the input setting without saving it and causing the inspection setting screen 800 to transition to the print management screen 600 illustrated in FIG. 6A. The list box 821 is used when various inspection areas are created. After pressing one of the inspection types in the list box 821, the operator sets the inspection area for the reference image displayed in the display area 805. For example, the inspection area 806 indicates a setting example of a print image inspection area in a case where the area of image inspection is selected in the list box 821. The inspection area 807 and the inspection area 808 indicate setting examples of an image data inspection area in a case where the area of data inspection is selected in the list box 821.

The setting area 831 (an example of “first object”) is an area in which correction of a composite position of a preprinted image and an RIP image to be executed in the preview image creation 233 can be input. That is, the operator can input a shift amount for moving the RIP image in the longitudinal direction or the lateral direction with reference to the preprinted paper. Considering a general printing apparatus, the input value preferably has a value range of about plus or minus 4.0 mm, but the input value is not limited to this range. On the inspection setting screen 800, a direction instruction button or the like may be displayed as a substitute for numerical value input, and the input value may be adjusted by operating this button. When an adjustment value is input, the CPU 223 accepts this input. Then, the CPU 223 returns to S1012 of FIG. 5A, re-creates the preview image according to the input value, and re-displays the preview image in the display area 805. This operation makes it possible to perform adjustment so that the variable area of the RIP image is printed at an appropriate position on the preprinted paper, while performing visual confirmation.

The setting area 831 includes the automatic adjustment button. Upon accepting the operation on the automatic adjustment button 832, the CPU 223 refers to the position of the inspection areas 807 to 809 of the RIP image displayed in the display area 805 stored in the storage apparatus 222 in past adjustment using the same preprinted paper. Then, the CPU 223 automatically adjusts the position of the print image with respect to the preprinted paper image. At this time, the CPU 223 may binarize each of the data of the fixed part of FIG. 7B and the data of the variable part of FIG. 7E. Then, the CPU 223 may automatically move the image for printing up, down, left, and right such that the fixed part and the variable part are at positions not overlapping the image printed in advance on the preprinted paper. Also in a case where the adjustment by the automatic adjustment button 832 is used, a numerical value is automatically input to the setting area 831. Then, the preview image is re-created according to the adjustment value, and is re-displayed in the display area 805. Thereafter, the operator may further input a value to the setting area 831 to perform fine adjustment.

The setting area 833 is a group of UIs for setting a currently selected area in the display area 805. The inspection setting screen 800 of FIG. 8 illustrates a display screen at the time of setting the front and back match inspection. Here, description will be given assuming that the currently selected area is the inspection area 806 displaying characters, but similar setting can be executed in the inspection area 809 displaying a barcode.

More specifically, in a case where the inspection area 806 or the inspection area 809 is selected, the operator can set the orientation thereof by pressing the button 836. The setting areas (837 and 838) are areas for selecting the inspection area 806 and the inspection area 809, and selecting the type of font in character string inspection and the type of barcode in barcode inspection.

The description returns to the sequence flows of FIGS. 5A and 5B. When the operator operates the button 811 to end the inspection setting registration in S1014, the CPU 223 of the inspection apparatus 200 accepts this operation. Then, the CPU 223 stores the inspection setting information into the storage apparatus 222 and uses it at the time of executing inspection. The CPU 223 (an example of “acceptance unit”) accepts the setting value of the setting area 831 on the inspection setting screen 800 using the network controller 221. Then, the CPU 223 (an example of “position correcting instruction unit”) transmits, to the image forming apparatus 100, this setting value and a correcting instruction of the print position according to this setting value, the correcting instruction being of the print position of the image data for printing to be printed on the preprinted paper. Then, the CPU 123 of the image forming apparatus 100 receives this setting value using the network controller 121.

In S1015, the CPU 123 of the image forming apparatus 100 corrects the print position at the time of printing the image data for printing onto the preprinted paper using the setting value received in S1014. The method for changing the print position includes, for example, a method for changing the image position with respect to the same A4 size frame as the recording paper when the RIP processing (RIP processing B134) for printing is executed. Note that the change method is not limited to this method, and may be, for example, a method for adjusting the position at which toner is transferred in the image forming stations 101 to 104.

In S1016, the CPU 123 executes the RIP processing B134. The RIP processing B134 is normal RIP processing, and, in a case where there are two images for printing, for example, RIP images (bitmap images) for printing as illustrated in FIGS. 7C and 7D are generated by VDP. In S1017, using the network controller 121, the CPU 123 transmits the RIP image created in S1016 to the inspection apparatus 200. Then, the inspection apparatus 200 receives this RIP image using the network controller 221.

In S1018, the CPU 123 of the image forming apparatus 100 prints the RIP image created in S1016. That is, in a case where the preprinted paper is loaded on the paper cassette 105, the CPU 123 feeds the preprinted paper from the paper cassette 105 to the paper conveyance path 109. Then, the CPU 123 transfers the toner to the intermediate transfer belt 108 on the paper conveyance path 109, and further transfers the toner to the preprinted paper. In this manner, the image for printing is overprinted on the preprinted paper. On the other hand, in the inspection apparatus 200, when printing is started, the CPU 223 brings the reading sensor into a scanning standby mode. Then, when the overprinted preprinted paper reaches immediately below the image sensor 201 of the inspection apparatus 200, the image sensor 201 reads the overprinted preprinted paper as an inspection target.

In S1019, the CPU 223 of the inspection apparatus 200 executes inspection 235 to perform contamination inspection. That is, using the paper distortion data acquired in S1003, the CPU 223 reproduces print distortion for each position on the RIP image received from the image forming apparatus 100 in S1017, and generates a reference image. Then, the CPU 223 compares the inspection image and the reference image for the inspection area 806 to determine that there is contamination in a case where the difference is a predetermined value or more.

In S1020, the CPU 223 of the inspection apparatus 200 executes the inspection 235 to perform data inspection. That is, the CPU 223 determines whether or not the data included in the inspection areas 807 to 809 matches the collation data designated in the collation CSV file 834. Then, in a case where the degree of matching is less than the predetermined value, the CPU 223 determines that the inspection target data does not match the collation data. Then, the processing ends.

### Paper Registration

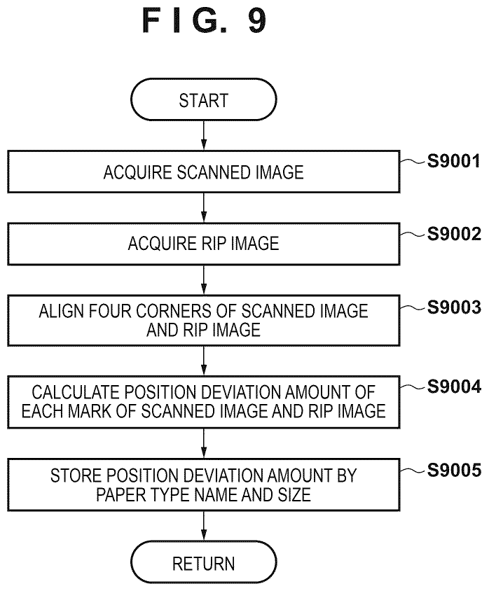

Details of the processing of the paper registration 231 in S1003 of the sequence flow of FIG. 5A will be described with reference to FIG. 9. Note that this processing is implemented by the CPU 223 of the inspection apparatus 200 reading a program stored in the storage apparatus 222 into the memory 224 and executing it.

In S9001, the reading unit 226 of the inspection apparatus 200 reads the paper registration pattern (FIG. 7A) formed on the sheet. Then, the CPU 223 acquires this scanned image data. In S9002, the CPU 223 executes the RIP processing B134 on the paper registration pattern (FIG. 7A) and acquires the created A4 size RIP image data.

In S9003, the CPU 223 aligns the scanned image with the RIP image such that the four corners of the scanned image and the RIP image match. Note that since the outer size of the RIP image is the A4 size, this alignment is based on the size of the paper to be actually printed. The alignment method is, for example, affine transformation. By such alignment, the position of each mark (+ mark in FIG. 7A) included in the scanned image data can be shifted.

In S9004, the CPU 223 calculates, as a position deviation amount in each of the longitudinal direction and the lateral direction, a difference between the positions of the marks (+ marks in FIG. 7A) of the scanned image data and the RIP image data aligned using the paper as a reference. In S9005, the CPU 223 (an example of “second acquisition unit”) stores, into the storage apparatus 222, the position deviation amount of each mark calculated in S9004 and the paper type designated by the paper type name 610 on the paper registration screen 630. In this manner, distortion data of the image generated when actually formed on paper is stored. Then, the processing returns to the sequence flows of FIGS. 5A and 5B.

### Preview Image Creation

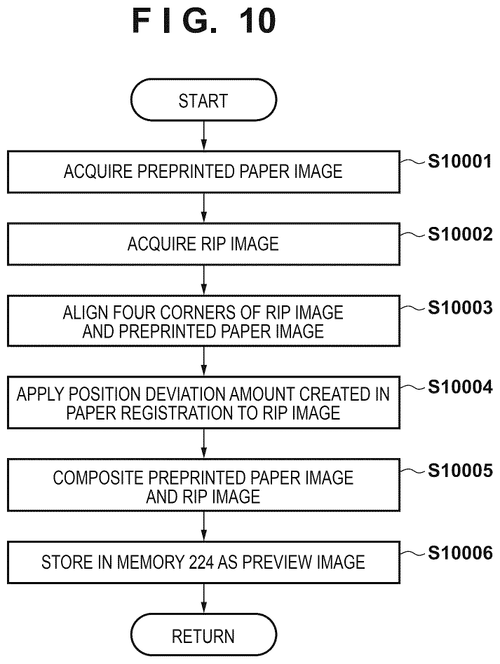

Details of the processing of the preview image creation 233 in S1012 of the sequence flow of FIG. 5A will be described with reference to FIG. 10. Note that this processing is implemented by the CPU 223 of the inspection apparatus 200 reading a program stored in the storage apparatus 222 into the memory 224 and executing it.

In S10001, the CPU 223 reads, from the storage apparatus 222, the preprinted paper image data registered by execution of the preprinted paper image registration 232 in S1006. In S10002, the CPU 223 acquires the A4 size RIP image data transmitted from the image forming apparatus 100 in S1011.

In S10003, the CPU 223 (an example of “transformation unit”) aligns, by a method such as affine transformation, a virtual paper end portion in a case where the A4 size RIP image data is printed on paper with respect to an end portion of the A4 size preprinted paper image. By such alignment, the position of the object included in the RIP image is also transformed so as to match the preprinted paper image.

In S10004, the CPU 223 applies the paper distortion acquired by execution of the paper registration 231 (FIG. 9) to the RIP image aligned in S10003. Since the distortion distance is stored for each pattern (+ mark) illustrated in FIG. 7A, the CPU 223 (an example of “processing unit”) executes distortion processing on the RIP image data at the position corresponding to the pattern for each pattern. Note that the CPU 223 corrects the image data by interpolation or the like regarding a pixel position having no pattern. For example, as illustrated in Japanese Patent Laid-Open No. 2023-180822, the CPU 223 uses non-rigid-body transformation represented by free form deformation (FFD). By doing this, it is possible to apply non-linear distortion occurring at the time of printing to the RIP image data.

In S10005, the CPU 223 composites the preprinted paper image data and the RIP image data subjected to the distortion processing in S10004. That is, the CPU 223 creates an alpha channel using a pixel in which an object exists in the RIP image data, and performs alpha composition on the RIP image data with respect to the preprinted paper image data. In S10006, the CPU 223 stores the image data composited in S10005 into the memory 224 as preview image data. Then, the processing proceeds to S1013 of FIG. 5A.

Note that in the present processing, in a case where it is required to print an image for printing in a frame, such as a case where the preprinted paper is a form or the like, the following processing may be executed. That is, in a case where portions in which pixel values exist overlap with each other at the time of compositing the preprinted paper image data and the RIP image data after being subjected to the distortion processing, the CPU 223 may cause the inspection setting screen 800 of FIG. 8 to display a warning message using the operation unit 225.

### One Aspect of Actions and Effects

According to the image inspection system 10 as described above, in a case of printing an image for printing onto preprinted paper, the user can perform inspection setting while referring to the inspection setting screen 800 displaying a preview image. This preview image is an image in which distortion when the image for printing is printed is taken into consideration. Hence, the user can correct the print position of the image for printing in consideration of this distortion and perform inspection setting of the inspection area 807 and the like. Hence, a decrease in inspection accuracy is suppressed.

According to the image inspection system 10 as described above, in a case where there are a plurality of images for printing, the variable data included in the preview image is data having the maximum size. Hence, by performing the inspection setting with reference to such a preview image, when the overprinting is actually performed, the variable data of the image for printing is suppressed from overlapping with an image outside the inspection target such as a ruled line printed in advance in preprint printing, for example. Also for these reasons, a decrease in inspection accuracy of the variable data is suppressed.

### Modification

In the above embodiment, by executing the RIP processing A133 in S1010, the CPU 223 extracts the data having the maximum size among the plurality of variable data positioned at the same coordinates over the plurality of inspection target images, and creates the RIP image of the inspection target. On the other hand, in this modification, a method for automatically acquiring variable data having a maximum size from among a plurality of variable data by image compositing will be described. Note that description of processing similar to that in the embodiment will be omitted as appropriate.

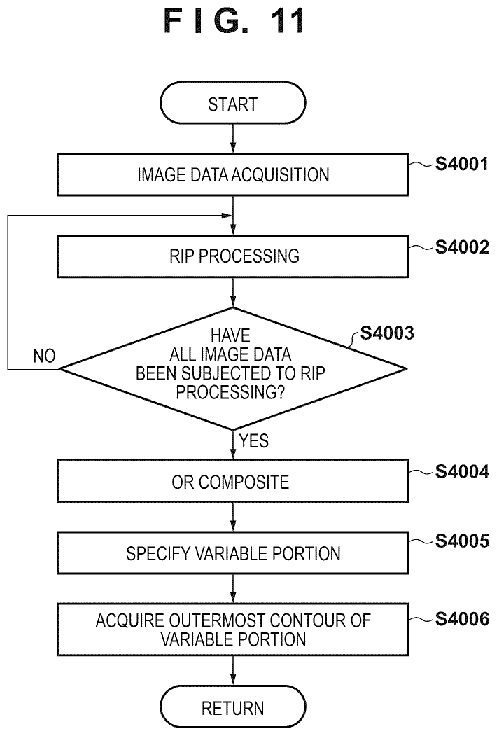

RIP processing A133 according to the modification will be described with reference to FIG. 11. Note that this processing is implemented by the CPU 123 of the image forming apparatus 100 reading a program stored in the storage apparatus 122 into the memory 124 and executing it.

In S4001, the CPU 123 of the image forming apparatus 100 acquires the image data of the inspection target transferred from the PC 400 in S1009. In S4002, the CPU 123 executes the RIP processing A133. That is, the CPU 123 generates RIP image (bitmap image) data of all frames for the image data of the inspection target. Then, the CPU 123 stores the generated RIP image data into the memory 124. It is assumed that the RIP image data stored in the memory 224 is data illustrated in FIGS. 7C and 7D, for example.

In S4003, the CPU 123 determines whether or not image data of all the inspection targets have been subjected to the RIP processing. Then, in a case where the CPU 123 determines that the RIP processing has been performed, the processing proceeds to S4004, and otherwise, the processing returns to S4002.

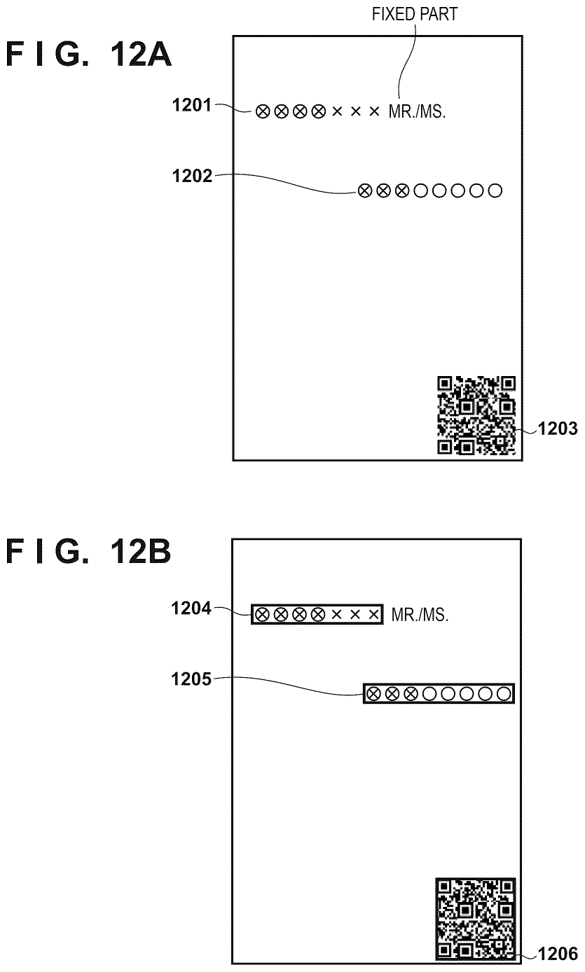

In S4004, the CPU 123 performs OR composite on the image data illustrated in FIGS. 7C and 7D. FIG. 12A illustrates a composite image having been subjected to OR composite. In the OR composite, variable data (1201 and 1202) and a QR code 1203 are changed, and data of the maximum size to be formed in each portion remains. Note that the processing of S4004 is an example of “taking a union of respective portions of a plurality of images for printing”.

In S4005, by comparing the image data before and after the OR composite, the CPU 123 automatically specifies the variable portion of the image data after the OR composite. Here, it is assumed that the CPU 123 specifies the variable data (1201 and 1202) and the QR code 1203 as variable portions.

In S4006, the CPU 123 extracts a contour using image processing such as contour tracking processing for each of the specified variable portions. FIG. 12B illustrates an image with the contour extracted. Then, the CPU 123 (an example of “compositing unit”) composites RIP image data including the fixed data, the variable data (1201 and 1202) subjected to the OR composite, the QR code 1203, and emphasized contours 1204 to 1206. The emphasis of the contours 1204 to 1206 is, for example, drawing with a thick line or drawing with a color line. Then, the processing proceeds to S1011 of FIG. 5A. By using such RIP image data in execution of the preview image creation 233, it becomes possible to create a preview image for which the size of the image of the variable portion is the maximum among all pages.

### Actions and Effects

Also according to a first modification, similar effects as those of the above embodiment can be achieved. According to the first modification, in order to create the preview image for which the size of the image of the variable portion is the maximum, the variable portion included in the plurality of images for printing can be automatically specified. Hence, the burden on the user can be reduced.

### Other Modifications

In the above embodiment, the inspection apparatus 200 includes the reading unit 226, but the reading unit may be provided outside the inspection apparatus 200 (e.g., the image forming apparatus 100). In such a case, the CPU 223 (an example of “third acquisition unit”) of the inspection apparatus 200 may acquire data read by the reading unit of the external apparatus via the LAN 500.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-025228, filed Feb. 19, 2025, which is hereby incorporated by reference herein in its entirety.

What is claimed is:

1. An inspection apparatus that inspects an abnormality of a sheet printed by an image forming apparatus, the inspection apparatus comprising:
one or more memory devices that store a set of instructions; and
one or more processors that execute the set of instructions to:
acquire an image for printing;
acquire a difference in position between the image for printing and the image for printing in a state of being printed on the sheet by the image forming apparatus;
acquire an image of a preprinted sheet;
execute processing on the image for printing according to the difference; and
output an inspection setting screen including the image for printing subjected to the processing and an image of the preprinted sheet.

2. The inspection apparatus according to claim 1, wherein
acquiring the difference includes
generating a first image including a predetermined pattern,
acquiring a second image in a state where the first image is printed on the sheet by the image forming apparatus,
transforming a position of the predetermined pattern included in the second image such that a position of a corner of the second image is aligned with a position of a corner of the first image, and
acquiring a difference between a position of the predetermined pattern included in the first image and a position of the predetermined pattern that is transformed and that is included in the second image.

3. The inspection apparatus according to claim 2, wherein
the one or more processors further execute instructions in the one or more memory devices to:
transform the image for printing such that a position of a corner of the image for printing is aligned with a position of a corner of the image of the preprinted sheet, and wherein
the one or more processors execute instructions in the one or more memory devices to:
execute the processing on the image for printing that is transformed.

4. The inspection apparatus according to claim 1, wherein
the inspection setting screen includes
a preview image in which the image for printing in a state of being subjected to the processing is superimposed on the image of the preprinted sheet, and
a first object for inputting a shift amount of a print position of the image for printing.

5. The inspection apparatus according to claim 4, wherein
the one or more processors further execute instructions in the one or more memory devices to:
accept input of a shift amount on the inspection setting screen; and
instruct a shift of a position at which the image for printing is printed on the preprinted sheet according to the shift amount that is accepted.

6. The inspection apparatus according to claim 1, wherein
the one or more processors further execute instructions in the one or more memory devices to:
output a print management screen, and wherein
the print management screen includes
a list for selecting an image for printing,
a second object for executing printing of the image for printing selected in the list,
a third object for setting an inspection of a sheet on which the image for printing is printed,
a fourth object for registering a type of a sheet on which the image for printing is printed, and
a fifth object for registering information on the preprinted sheet.

7. The inspection apparatus according to claim 1, wherein
acquiring the image of the preprinted sheet includes reading the image of the preprinted sheet.

8. An inspection system comprising:
the inspection apparatus according to claim 1; and
the image forming apparatus, wherein
the one or more processors in the image forming apparatus execute instructions in the one or more memory devices to:
transmit the image for printing to the inspection apparatus.

9. The inspection system according to claim 8, wherein
there are a plurality of the images for printing, and the plurality of images for printing include a variable part that changes for each frame and a fixed part that does not change for each frame, and wherein
the one or more processors in the image forming apparatus further execute instructions in the one or more memory devices to:
composite the fixed part and the variable part whose size when printed on the sheet is maximum among a plurality of the variable parts, and wherein
the one or more processors in the image forming apparatus execute instructions in the one or more memory devices to:
transmit a composite image as the image for printing to the inspection apparatus.

10. The inspection system according to claim 9, wherein
the variable part includes a character, and wherein
the one or more processors in the image forming apparatus execute instructions in the one or more memory devices to:
compare the character of the plurality of images for printing, and composite the character that has a largest number of characters, as the variable part whose size is maximum, and the fixed part.

11. The inspection system according to claim 9, wherein
the variable part includes a two-dimensional code, and wherein
the one or more processors in the image forming apparatus execute instructions in the one or more memory devices to:
compare a data amount of the two-dimensional code of the plurality of images for printing or a size when the two-dimensional code is printed on the sheet to composite the two-dimensional code of which the data amount or the size when printed on the sheet is maximum, as the variable part whose size is maximum, and the fixed part.

12. The inspection system according to claim 9, wherein
the one or more processors in the image forming apparatus execute instructions in the one or more memory devices to:
take a union of each image of the plurality of images for printing to composite them;
compare the image for printing before taking the union and a composite image after taking the union to specify the variable part,
extract a contour of the variable part that is specified, the variable part after taking the union, and
composite the variable part after taking the union, the contour that is extracted, and the fixed part.

13. A control method for an inspection apparatus that inspects for an abnormality of a sheet printed by an image forming apparatus, the control method comprising:
acquiring an image for printing;
acquiring a difference in position between the image for printing and the image for printing in a state of being printed on the sheet by the image forming apparatus;
acquiring an image of a preprinted sheet;
executing processing on the image for printing according to the difference; and
outputting an inspection setting screen including the image for printing subjected to the processing and an image of the preprinted sheet.
